(19) United States
(12) Patent Application Publication
(10) Pub. No.: US 2014/0236566 A1
(43) Pub. Date: Aug. 21, 2014

(54) COMPUTER SYSTEM AND COMPUTER IMPLEMENTED METHOD OF SETTING UP LANGUAGE TRANSLATION SERVICES

(71) Applicant: Reinhard Schreier, Winterthur (CH)

(72) Inventor: Reinhard Schreier, Winterthur (CH)

(21) Appl. No.: 13/772,060

(22) Filed: Feb. 20, 2013

(51) Int. Cl. G06F 17/28

(52) U.S. Cl. CPC G06F 17/28
USPC 704/2

(57) ABSTRACT

The invention relates to a computer system and method of setting up language translation services. The computer system is programmed to implement at least: a registration module configured to receive translator profile data via a telecommunication network from human translators, and to store the translator profile data, the translator profile data including at least one source language and one target language; a service request module configured to receive translation request data via the telecommunication network from clients, and to store the translation request data, the translation request data including at least a source language and a target language; and a matching module configured to determine a set of human translators suitable for a translation request received from a client, using the translator profile data and the translation request data, and to set up a communication link between the client and a human translator selected from the set of human translators. In particular, the computer system enables translation for a client contacting a human translator or translation in a triangle client—human translator—communication partner, wherein oral or written translation services in particular of telephone calls, e-mails, sms messages, pictures containing text, etc. are instantly provided.

### TECHNICAL FIELD

The present invention relates to a computer system and computer implemented method of setting up language translation services.

### BACKGROUND

Translation services provide translation from a source language into a target language. Human translation still provides better quality than machine translation. However, human translation may be slow with respect to machine translation, in particular in case of translation of large written documents. For a client with a need for translation services, it is often very difficult and time consuming to find and evaluate a human translator providing translation services at a desired quality and price. Even if a client knows a human translator offering the desired quality and price, the human translator may be already fully booked or absent because of holidays or a business trip, and therefore translations may not be available within reasonable time.

U.S. Pat. No. 6,292,769 discloses an online information service to participate in real-time conferencing. A message originating from a subscriber is translated from a first language into one or more further languages. The translations are broadcast to other conference areas. Translation occurs automatically through languages translation capabilities resident at online information service host computers. Access software of subscribers includes speech recognition and speech generation software such that a subscriber may speak messages and hear messages.

U.S. Pat. No. 6,996,520 discloses translation of electronic communications, wherein upon context recognition and other factors specialized dictionaries are selected and deployed. Speech and text input is accepted. Translation of electronic mail, instant messages, chat, SMS messages, electronic text and word processing files, Internet web pages, Internet search results, and other textual communication is provided. Language pairs may be determined automatically.

WO 2009/072133 discloses a translation system for translation of online chats in order to enable a multiplicity of users to communicate. The system comprises a dictionaries database enabling to store a multiplicity of lingual dictionaries. A translation module enables online translation of the content of a multiplicity of languages into a multiplicity of other languages. The dictionaries database is used to execute the online translation according to predefined rules and user's selections.

CN101873239 discloses an instant translation system with multilingual translation. Integration of international translation resources and communication of translation services is realized by utilizing modern network topology, short messages and an audio telephone communication technology. People around the world can obtain the translation services such as instant oral interpretation, short message translation, on-line written translation, and the like in real time through the Internet, short message platforms, and audio telephones.

### SUMMARY OF THE INVENTION

It is an object of this invention to provide a computer system and a computer implemented method of setting up language translation services, which do not have at least some of the disadvantages of the prior art. In particular, it is an object of this invention to provide a computer system and a computer implemented method of setting up language translation services to provide instant translation from a source language into a target language. In particular, it is an object of this invention to provide a computer system and a computer implemented method of setting up language translation services for oral or written translations, either between a client and a human translator or in a triangle client—human translator—communication partner, wherein, for example, e-mail messages, phone calls, sms messages, pictures containing text, etc. are instantly translated by a human translator.

According to the present invention, these objects are achieved through the features of the independent claims. In addition, further advantageous embodiments follow from the dependent claims and the description.

According to the present invention, the above-mentioned objects are particularly achieved in that a computer system comprising one or more processors is programmed to implement at least: a registration module configured to receive translator profile data via a telecommunication network from human translators, and to store the translator profile data, the translator profile data including at least one source language and one target language; a service request module configured to receive translation request data via the telecommunication network from clients, and to store the translation request data, the translation request data including at least a source language and a target language; and a matching module configured to determine a set of human translators suitable for a translation request received from a client, using the translator profile data and the translation request data, and to set up a communication link between the client and a human translator selected from the set of human translators. Preferably, the telecommunication network relates to the Internet providing communication links via the Internet Protocol. Accordingly, human translators may register world-wide to the computer system and transmit translator profile data. As such, a self developing network that contains at the end all possible language translations is established. Clients may access the computer system world-wide as well and transmit translation request data. Hence, the computer system enables that for requested translations services, an adequate human translator is selected out of a world-wide pool of translators. Accordingly, translation services may be instantly provided, because an adequate human translator may be instantly selected out of a large and growing pool of human translators. The translation services may involve the client and the human translator, wherein the client may send source language to a human translator and receive translated target language from the translator, either in written form or orally. The translation services may involve the triangle client—human translator—communication partner, wherein the client may communicate with a communication partner that cannot communicate directly with each other since they do not speak the same language.

In an embodiment, the translation request data further includes addressing data of a communication partner assigned to the target language, and the matching module is further configured to set up a communication link between the communication partner and the selected human translator, using the addressing data of the communication partner, for enabling the selected human translator to act as an interpreter between the client and the communication partner. Accordingly, the client is not only connected instantly with a suitable human translator, but at the same time with a communication partner with whom the client desires to communicate with. Hence, conversation of the client with a person who does not speak the language of the client is instantly enabled through the human translator.

In an embodiment, the matching module is configured to set up the communication link using Voice over Inter Protocol, a video conference session, a telephone connection, a conference call connection, and/or instant messaging services. The communication of the client with the human translator and/or the communication partner is therefore instantly enabled using reliable, widely deployed technologies.

In an embodiment, the service request module is configured to receive and store text data from clients; and the matching module is further configured to transmit the text data to the human translator, to receive translated text data from the human translator, and to transmit translated text data to the client. By storing text data, it is not required that the human translator is available at the same time as the client transmits the translation request. Accordingly, the client can instantly transmit a translation request, without further negotiations with the human translator, in particular in case of large text documents which require a certain time period anyway until translation is finished.

In an embodiment, the registration module is further configured to receive and store availability information for the human translators; and the matching module is further configured to determine the set of human translators using the availability information. Accordingly, instant translation can be further improved as translation is relied upon only on available human translators.

In an embodiment, the service request module is further configured to receive and store scheduling information; and the matching module is further configured to set up the communication link between the client and the human translator using the scheduling information. Accordingly, instant translation can be further improved as translation is relied upon according to the scheduling needs of the client

In an embodiment, the matching module is further configured to enable a cost of service negotiation between the client and the human translator, and to store a service agreement including an agreed upon cost of service. Accordingly, billing of instant translation is more reliable as it is based on agreed cost of services.

In an embodiment, the computer system is further programmed to implement a calculation module configured to calculate and store service costs for a translation request using cost of translation services for oral translation, cost of translation services for written translation, source language, target language, subject of expertise, level of translation difficulty, certificate of language skill, quality rating of human translator, number and languages of translation services performed by human translator, duration and languages of translation services performed by human translator, and/or date of registration of human translator. Accordingly, billing of instant translation services is more reliable as it is based according to the quality and cost of the human translator. The service costs are billed to the client after use of the translation service, in particular via a widely deployed on-line billing system.

In an embodiment, the service request module is further configured to receive and store with the translation request data levels of requested translation difficulty, certificates of required language skills, cost of translation services for oral translation, cost of translation services for written translation, required subjects of expertise, and/or place of residence. Accordingly, in evaluation of aforementioned items by the matching module, for example, selection of a human translator and therefore instant translation are improved, as selection of a human translator is performed according to more precisely defined translation requirements of clients.

In an embodiment, the registration module is configured to further receive and store with the translator profile data levels of offered translation difficulty, certificates of language skills, cost of translation services for oral translation, cost of translation services for written translation, subjects of expertise, place of residence, time zone, working hours, quality ratings, client references, number and languages of performed translation services, duration and languages of performed translation services, and/or date of registration. Accordingly, in evaluation of the aforementioned items by the matching module, for example, reliability in selecting a human translator is improved, as selection of a human translator is performed according to more precisely defined profile data of human translators.

In addition to a computer system for setting up language translation services, the present invention also relates to a computer implemented method of setting up language translation services, the method comprising: receiving translator profile data via a telecommunication network from human translators, and storing the translator profile data in a computer system, the translator profile data including at least one source language and one target language; receiving translation request data via the telecommunication network from clients, and storing the translation request data in the computer system, the translation request data including at least a source language and a target language; determining in the computer system a set of human translators suitable for a translation request received from a client, using the translator profile data and the translation request data; and setting up by the computer system of a communication link between the client and a human translator selected from the set of human translators.

In an embodiment, the translation request data further includes addressing data of a communication partner assigned to the target language, and the communication link is set up between the communication partner and the selected human translator, using the addressing data of the communication partner, to enable the selected human translator to act as an interpreter between the client and the communication partner.

In an embodiment, the communication links are set up using at least one of: Voice over Inter Protocol, video conference session, telephone connection, conference call connection, and instant messaging services.

In an embodiment, the method further comprises receiving and storing in the computer system text data from clients; transmitting the text data to the human translator; receiving translated text data from the human translator; and transmitting translated text data to the client.

In an embodiment, the method further comprises receiving and storing in the computer availability information of the human translators; and determining the set of human translators using the availability information.

In an embodiment, the method further comprises receiving and storing in the computer system scheduling information; and setting up the communication link between the client and the human translator using the scheduling information.

In an embodiment, the method further comprises negotiating in the computer system a cost of service between the client and the human translator; and storing a service agreement including an agreed upon cost of service.

In an embodiment, the method further comprises calculating and storing in the computer system service costs for a translation request, using at least one of: cost of translation services for oral translation, cost of translation services for written translation, source language, target language, subject of expertise, level of translation difficulty, certificate of language skill, quality rating of human translator, number and languages of translation services performed by human translator, duration and languages of translation services performed by human translator, and date of registration of human translator.

In an embodiment, the method further comprises receiving and storing in the computer system translation request data including at least one of: levels of requested translation difficulty, certificates of required language skills, cost of translation services for oral translation, cost of translation services for written translation, required subjects of expertise, and place of residence; and receiving and storing in the computer translator profile data including at least one of: levels of offered translation difficulty, certificates of language skills, cost of translation services for oral translation, cost of translation services for written translation, subjects of expertise, place of residence, time zone, working hours, quality ratings, client references, number and languages of performed translation services, duration and languages of performed translation services, and date of registration.

In addition to a computer system and a computer implemented method of setting up language translation services, the present invention also relates to a computer program product comprising a computer readable medium having stored thereon computer program code configured to control one or more processors of a computer system such that the computer system performs the steps of: receiving translator profile data via a telecommunication network from human translators, and storing the translator profile data, the translator profile data including at least one source language and one target language; receiving translation request data via the telecommunication network from clients, and storing the translation request data, the translation request data including at least a source language and a target language; determining a set of human translators suitable for a translation request received from a client, using the translator profile data and the translation request data; and setting up a communication link between the client and a human translator selected from the set of human translators.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1 shows a block diagram illustrating schematically an instant translation matrix (ITM) according to the invention;

FIG. 2 shows a block diagram illustrating schematically a computer system according to the invention;

FIG. 3 shows a flow diagram illustrating an exemplary sequence of steps for setting up language translation services;

FIG. 4 shows a flow diagram illustrating a first further exemplary sequence of steps for setting up language translation services;

FIG. 5 shows a flow diagram illustrating a second further exemplary sequence of steps for setting up language translation services; and

FIG. 6 shows a flow diagram illustrating a third further exemplary sequence of steps for setting up language translation services.

### DETAILED DESCRIPTION

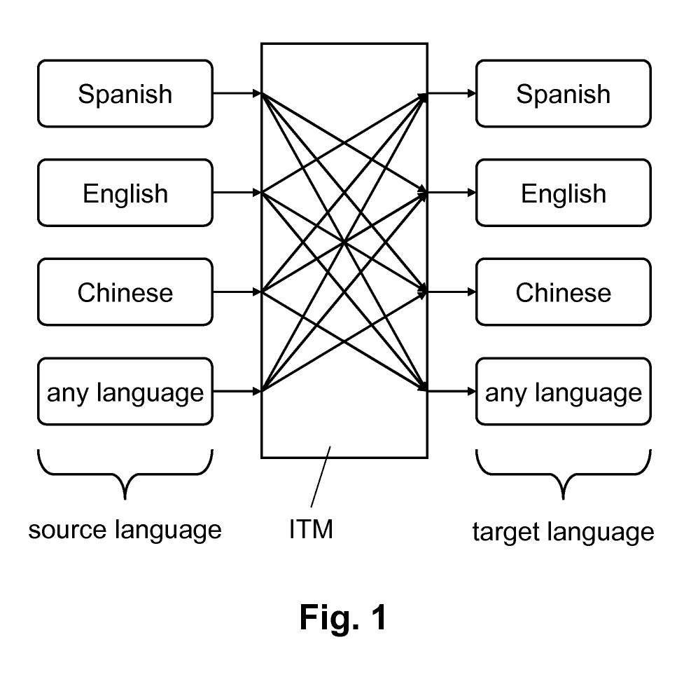

FIG. 1 shows a block diagram illustrating schematically an instant translation matrix (ITM) according to the invention. The ITM provides translation from a source language into a target language. The source language is the language from which it is translated from, in particular the language of a source text. The target language is the language to which the source text is translated. The source language may include Spanish, English, French, or any other language. The target language may include Spanish, English, French, or any other language. The source language differs from the target language, as otherwise no translation is required.

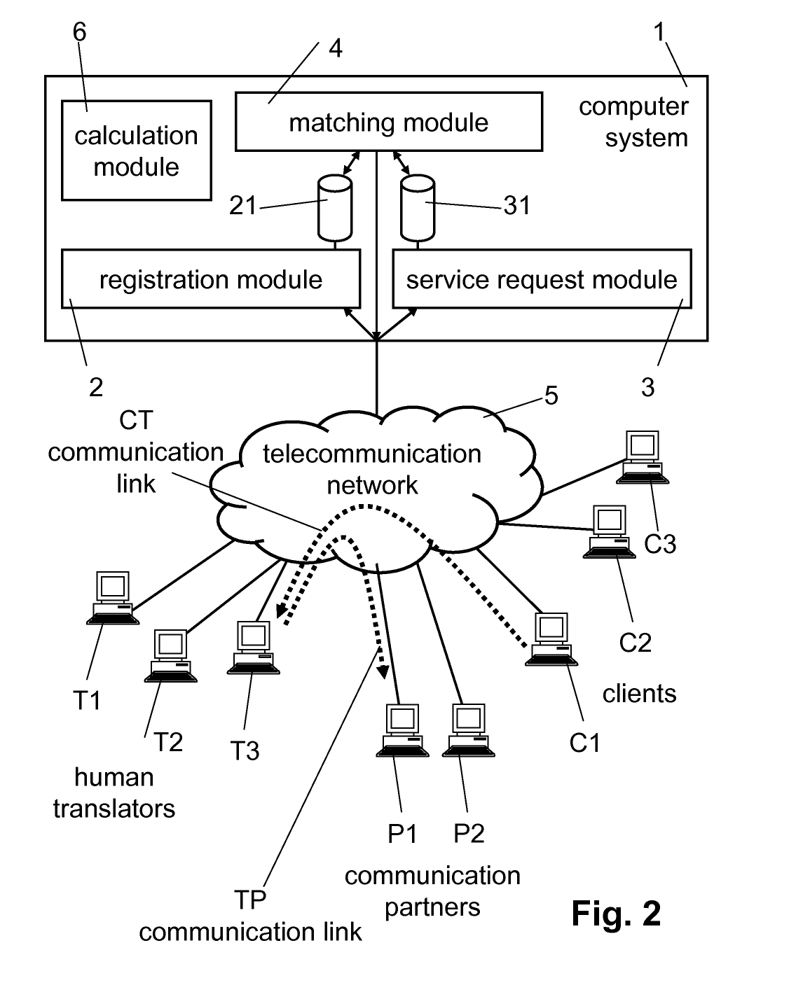

FIG. 2 shows a block diagram illustrating schematically a computer system 1 comprising one or more processors. In a variant, the computer system 1 is a personal computer or a laptop computer running an operating system such as Microsoft Windows®, Apple OS X®, Linux, etc. In a variant, the computer system 1 is a server running an operating system such as Microsoft Windows Server®, Apple OS X Server®, Linux, etc. In a variant, the computer system 1 is a mobile device such as a tablet computer or a mobile phone running an operating system such as Apple iOS®, Android®, etc.

As shown schematically in FIG. 2, the computer system 1 is programmed to implement a registration module 2, a service request module 3, and a matching module 4. In an embodiment, the computer system 1 is programmed to provide a registration database 21 accessible by the registration module 2 and the matching module 4. In a variant, the computer system 1 is programmed to provide a request database 31 accessible by the service module 3 and the matching module 4.

As schematically shown in FIG. 2, the computer system 1 is connected to a telecommunication network 5, which provides data communication services, voice communication services, video communication services, etc. between network devices such as computers, telephones, video cameras, etc. In a variant, the telecommunication network 5 is the Internet providing worldwide communication between internet devices via the Internet Protocol. In a variant, the computer system 1 includes a communication interface providing communication services with the Internet via the Internet Protocol.

As schematically shown in FIG. 2, translator terminals T1, T2, T3, client terminals C1, C2, C3, and partner terminal P1, P2 are connected to the telecommunication network 5. The translator terminals T1, T2, T3, client terminals C1, C2, C3, and partner terminal P1, P2 may include personal computers, tablet computers, mobile telephones, etc. which include a user interface comprising a keyboard, a display, a touchscreen, etc. configured for interaction between the terminal and a human user of the terminal, in particular between a translator terminal T1, T2, T3 and a human translator providing translation services, between a client terminal C1, C2, C3 and a client requiring translation services, or a partner terminal P1, P2 and a human communication partner involved. In a variant, the translator terminals T1, T2, T3, the client terminals C1, C2, C3, and the partner terminal P1, P2 include a communication interface providing communication services with the Internet via the Internet Protocol. In a variant, the translator terminals T1, T2, T3, the client terminals C1, C2, C3, and the partner terminal P1, P2 include a personal computer, a tablet computer, a mobile phone, or any other terminal running Microsoft Windows®, Apple OS X®, Apple iOS®, Android®, Linux, or any other operating system.

The registration module 2 of the computer system 1 is configured to receive translator profile data via the telecommunication network 5 from human translators. In a variant, a human translator enters translator profile data via the user interface of a translator terminal T1, T2, T3, wherein translator profile data is sent to the registration module via the telecommunication network 5. For example, on a translator terminal T1, T2, T3, an input mask with data fields is displayed, which are to be filled out by the human translator in order to complete the translator profile data. As soon as the human translator has finished to fill out the data fields, the corresponding translator terminal T1, T2, T3 sends the translator profile data to the registration module 2, wherein translator profile data is received by the registration module 2.

Translator profile data includes at least a source language and a target language. The source language and the target language may include languages such as Spanish, English, Chinese, Japanese, French, German, etc. The translator profile data may include as a target language a first language (also native language, mother tongue) of a human translator, which the human translator has learned from birth, for example. In case the human translator had parents speaking different languages, the translator profile data may include both of the parent's languages as target languages. In a variant, the translator profile data may include even further target languages which the human translator is able to translate into. The translator profile data may include as source languages one or more foreign languages, which the human translator has learned and which the human translator is able to translate from. For written translation, the translator profile data may include different source languages and/or target languages than for oral translation.

As schematically shown in FIG. 2, the computer system 1 is programmed to implement a service request module 3, which is configured to receive translation request data via the telecommunication network 5 from clients. In a variant, a client enters translation request data via the user interface of a client terminal C1, C2, C3, wherein translation request data is sent to the service request module 3. For example, on the client terminal C1, C2, C3, an input mask with data fields is displayed, which are to filled out by the client in order to complete the translation request data. As soon as the client has finished to fill out the data fields, the corresponding client terminal C1, C2, C3 sends the translation request data to the service request module 3, wherein translation request data is received by the service request module 3.

Translation request data includes at least a source language and a target language. The source language and the target language may include languages such as Spanish, English, Chinese, Japanese, French, German, etc. In a variant, the translation request data may include one source language and several target languages, which the source language has to be translated into.

As schematically shown in FIG. 2, the computer system 1 is programmed to implement a matching module 4, which is configured to determine a set of human translators suitable for a translation request received from a client, using the translator profile data and the translation request data, and to set up a communication link between the client and a human translator selected from the set of human translators, as schematically shown in FIG. 2. In particular, via the telecommunication network 5, a communication link CT between a client terminal C1, C2, C3 and a translator terminal T1, T2, T3 is set up. In a variant, the communication link CT between the client terminal C1, C2, C3 and the translator terminal T1, T2, T3 is bi-directional, such that the client is able to transmit source language to the human translator, wherein the translation of the human translator into the target language is transmitted back to the client. Source language and the translation into the target language is transmitted between the client and the human translator orally and/or in writing.

As indicated schematically in FIG. 2, the computer system 1 may include a profile database 21 for storing translator profile data of several human translators and/or a request database 31 for storing translation request data of several clients. The profile database 21 and/or request database 31 may include any suitable database management system, such as, for example, Oracle, IBM DB2, Microsoft SQL Server, MySQL, etc. Accordingly, the registration module 2 is configured to store in the profile database 21 translator profile data received via the telecommunication network 5 from translator terminals T1, T2, T3 and the corresponding human translators, and to store in the request database 31 translation request data received via the telecommunication network 5 from client terminal C1, C2, C3 and the corresponding clients. In a variant, the matching module 4 is configured to access data stored in the profile database 21 and/or data stored in the request database 31. In a variant, the profile database 21 and/or request database 31 may include translator profile data of several hundred, several thousand or more human translators and/or translation request data of several hundred, several thousand or more clients, wherein the matching module 4, by access to the profile database 21 and to the request database 31, determines a set of human translators suitable for a translation request stored in the request database 31, and to set up a communication link CT between the client terminal C1, C2, C3 of the corresponding client and a translator terminal T1, T2, T3 of the human translator selected from the set of human translators.

In a variant, the translation request data received by the service request module 3 further includes addressing data of a communication partner assigned to the target language, and the matching module 4 is further configured to set up a communication link between the communication partner and the selected human translator, using the addressing data of the communication partner for enabling the selected human translator to act as an interpreter between the client and the communication partner. In particular, via the telecommunication network 5, a communication link TP between the translator terminal T1, T2, T3 of the human translator and the partner terminal P1, P2 of the communication partner is set up. In a variant, the communication link CT between the client terminal C1, C2, C3 and the translator terminal T1, T2, T3, and the communication link TP between the translator terminal T1, T2, T3 and the partner terminal P1, P2 are bi-directional, such that the human translator receives source language to be translated into a target language from the client and transmits the translation to the communication partner, wherein the communication partner transmits a response in the target language to the human translator, who translates the response into the source language and transmits the translation to the client. Accordingly, the human translator enables bi-directional communication between a client and a communication partner, each of them using their own languages. Such bi-directional communication may be in writing or oral.

The communication link CT between the client terminal C1, C2, C3 and the translator terminal T1, T2, T3 and/or the communication link TP between the translator terminal T1, T2, T3 and the partner terminal P1, P2 may be set up using an address defined in the Internet to set up communication links, such as an email address, an address registered in a DNS system (DNS: domain name system), or any other address. Accordingly, the communication link between the client and the human translator and/or the communication link between the human translator and the client may be set up using a Voice over Internet Protocol, a video conference session, a conference call connection, instant messaging services, etc. In a variant, the communication link between the client and the human translator and/or the communication link between the human translator and the communication partner are provided using applications such as Skype®, ICQ®, iChat®, Yahoo! Messenger®, or similar. In a variant, the communication link is adapted to transmit SMS (short message system) messages, e-mail messages, telephone conversations, etc.

In a variant, the service request module 3 is configured to receive and store text data from clients, for example via a communication link CT established between the client terminal C1, C2, C3 of the client and the service request module 3. For example, the text data is received and stored together with the service request data, in particular such that the text data is accessible by the matching module 4. The matching module 4 is further configured to transmit the text data to the human translator, for example via a communication link TP established between the matching module 4 and the translator terminal T1, T2, T3 of the corresponding human translator. The matching module 4 is configured to receive translated text data from the translator terminal T1, T2, T3 of the human translator, for example via the communication link TP established between the matching module 4 and the translator terminal T1, T2, T3 of the human translator, and to transmit translated text data to the client terminal C1, C2, C3, for example via the communication link CT established between the client terminal C1, C2, C3 of the client and the matching module 4. Accordingly, the client sends text data to be translated to the service request module 3 together with the service request data. The matching module 4 selects a human translator and forwards the text data to be translated. After the human translator has finished translation, which may take several days or weeks depending on the size of the text data, the translation is forwarded to the client.

In a variant, the registration module 2 is configured to receive and store availability information for the human translators. Availability information may include time information such as day of week, time of day, geographical time zone etc. For example, a translator may specify that with respect to the time zone MET, translation services are available between 8 am-6 pm on weekdays, or between 10 am-3 pm on Monday and Tuesday, or everyday between 6 pm-10 pm, etc. In particular, availability information is stored such that it is accessible by the matching module 4. The matching module 4 is further configured to determine the set of human translators using the availability information. For example, in case of oral translation, the set of human translators includes only translators which are available at the time the oral translation shall take place. In another example, in case of written translation, the set of human translators includes only translators which are available until the deadline when the translation has to be finished.

In a variant, the service request module 3 is further configured to receive and store scheduling information. Scheduling information may include date, time period, geographical time zone, etc. For example, scheduling information may include the date 31 Jun. 2013, the time period 9 am-10 am, and the time zone MET. In particular, scheduling information is stored such that it is accessible by the matching module 4. The matching module 4 is further configured to set up the communication link CT between the client terminal C1, C2, C3 of a client and the translator terminal T1, T2, T3 of a human translator using the scheduling information. According to the example the communication link CT is setup at 31 Jun. 2013, between 9 am-10 am MET. In a variant, the communication link CT is setup such that communication between the client and the human translator may take place as desired, namely that the communication link CT is terminated if translation is finished before 10 am, or that the communication link CT is maintained if translation has not been finished before 10 am. In a variant, for example the matching module 4 is configured to determine if the client and the human translator are still using communication link CT, and to terminate the communication link CT if this is not the case anymore. In a variant, scheduling information includes a date until a translation shall be finished, in particular in case of a written translation.

In a variant, the matching module 4 is further configured to enable a cost of service negotiation between the client and the human translator, and to store the service agreement including an agreed upon cost of service. In a variant, a communication link set up between the client terminal C1, C2, C3 of the client and the translator terminal T1, T2, T3 of the human translator is used for negotiating a service agreement orally and/or in writing. A written service agreement may be included in an electronic document and electronically signed using electronic signatures of the client and the human translator, wherein the electronically signed service agreement is stored in the matching module 4, for example. Accordingly, the agreed upon service agreement between the client and the human translator can be verified at a later stage, in particular in case the view of the client differs from the view of the human translator.

In a variant, the computer system 1 is further programmed to implement a calculation module 6, as schematically shown in FIG. 2, configured to calculate and store service costs for a translation request.

The service costs may depend on the cost of translation for services for oral or for written translation. For example, the cost for oral translation may be calculated depending on a rate per minute, such as an amount in USD/min., wherein the cost for written translation may be calculated depending on a rate per line or word, such as an amount in USD/line or USD/word.

The service costs may depend on the source language and/or the target language. In particular if a language combination is involved where only few translators are available, the costs may be higher than in case of a language combination where plenty of translators are available.

The service costs may depend on the subject of expertise, the level of translation difficulty, a required certificate of language skill, a quality rating of a human translator, the number and languages of translation services performed by a human translator, duration and languages of translation services performed by a human translator, and/or date of registration of human translator. Accordingly, the service costs may be calculated precisely in accordance to the skill and expertise of a human translator. In particular, a certificate of language skill may include a Cambridge Certificate of Proficiency in English, Certificado de Español, Test of Chinese as a Foreign Language, etc., which attest language skills to the human translator. A quality rating of a human translator may include ratings of clients who already used the translation services of the human translator. The subject of expertise may include topics such as electronics, physics, medicine, law, art, etc.

In a variant, the service request module 3 is further configured to receive and store with the translation request data levels of translation difficulty, certificates of required language skills, cost of translation services for oral translation, cost of translation of for written translation, required subjects of expertise, and/or place of residence.

In a variant, the service request module 4 is configured to receive and store with the translation request data items such as levels of requested translation difficulty, certificates of required language skills, cost of translation services for oral translation, cost of translation services for written translation, required subjects of expertise, and/or place of residence. In a variant, the matching module 4 is configured to take into account one or more of these items to determine a set of human translators suitable for a translation request, in particular using stored translator profile data of the human translators. For example, if a certain level of requested translation difficulty is requested, a human translator is only added to the set of human translators suitable for a translation request if the translator profile data indicates that the human translator has a level which is equal or above the requested level. Accordingly, a human translator is added only if the translator profile indicates that certificates of language skills, cost of translation services, subject of expertise, and place of residence are in accordance with the service request.

In a variant, the registration module 3 is configured to further receive and store with the translator profile data items such as levels of offered translation difficulty, certificates of language skills, cost of translation services for oral translation, cost of translation services for written translation, subjects of expertise, place of residence, time zone, working hours, quality ratings, client references, number and languages of performed translation services, duration and languages of performed translation services, and/or date of registration. According to the items stored with the translator profile data, the matching module 4 is enabled to add a human translator to the set of human translators suitable for a translation request received from a client.

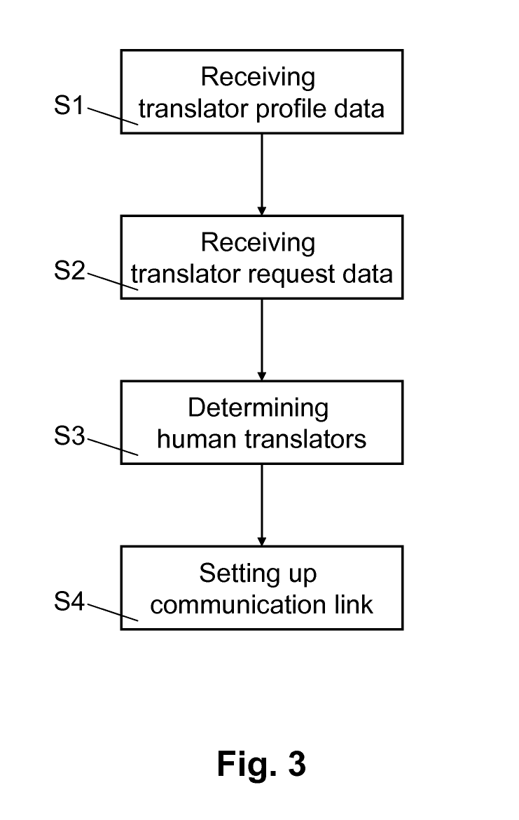

FIG. 3 shows a flow diagram illustrating an exemplary sequence of steps for setting up language translation services.

In step S1, translator profile data is received via a telecommunication network 5 from human translators, and the translator profile data is stored in the computer 1, the translator profile data including at least one source language and one target language. In particular, the translator profile data is received from world-wide domiciled human translators, wherein translator profile data is stored in the computer 1 linked to the corresponding human translator. As more and more translator profile data is received and stored in the computer 1, more and more translator profile data including different combinations of a source language and a target language is stored in the computer 1.

In step S2, translation request data is received via the telecommunication network 5 from clients, and the translation request data is stored in the computer 1, the translation request data including at least a source language and a target language. Accordingly, one ore more requests from one or more clients to translate from a source language into a target language is received and stored in the computer 1.

In step S3, in the computer a set of human translators is determined suitable for a translation request received from a client, using the translator profile data and the translation request data. In particular, the set of human translators includes human translators capable to translate from the source language to the target language as defined in the translation request data received from the clients.

In step S4, a communication link between the client and a human translator selected from the set of human translators is setup by the computer. For example, the human translator may be selected randomly from the set of human translators. In a variant, the communication link is setup via the telecommunications network 5.

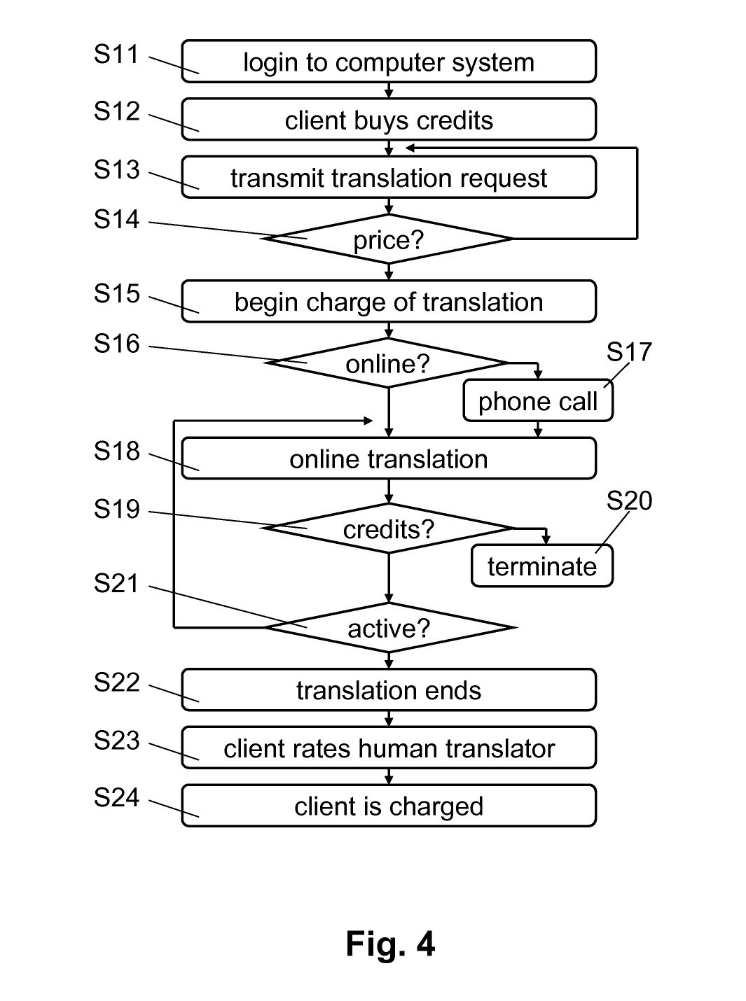

FIG. 4 shows a flow diagram illustrating a first further exemplary sequence of steps for setting up language translation services. This example relates to the case when a client has to call somebody who does not speak his language at all, wherein a human translator provides instant translation.

In step S11, a client logs into the computer system 1, for example by providing a username and password assigned to the client's account. In step S12, the client buys credits, for example using a credit card or electronic payment system. In step S13, the client transmits a translation request to the computer system, indicating a source language, a target language, and a communication partner. In response, the client receives contact of a human translator and contacts the human translator. In step S14, the client and the human translator negotiate and try to agree on the price and costs for translation services. If they do not agree, the client looks for another translator and returns to step S13. If they agree, in step S15 the begin of charge of translation services is started and the human translator contacts the communication partner as indicated by the client. In step S16, the human translator tries to contact the communication partner online on the computer system 1. If this is not successful, in step S17 the human translator contacts the communication partner by telephone, whereas the telecommunication costs are charged to the client. In step S18, the human translator translates between the client and the communication partner, whereas the translation services are charged to the client. In step S19, for example after a time interval, it is checked if the credits of the client are not empty. In case the credits are empty, in step S20 translation is terminated and the client has to buy further credits. In step S21, it is checked if translation between the client and the communication partner is still active, for example by transmitting a confirmation request to the human translator. If translation is still active, translation is continued at step S18. If translation is not active anymore, translation is ended at step S22. In step S23, the client rates the human translator by transmitting rating data to the computer system 1. In step S24, the client is charged for the translation services by transferring an amount of money from an account of the client to an account of the human translator.

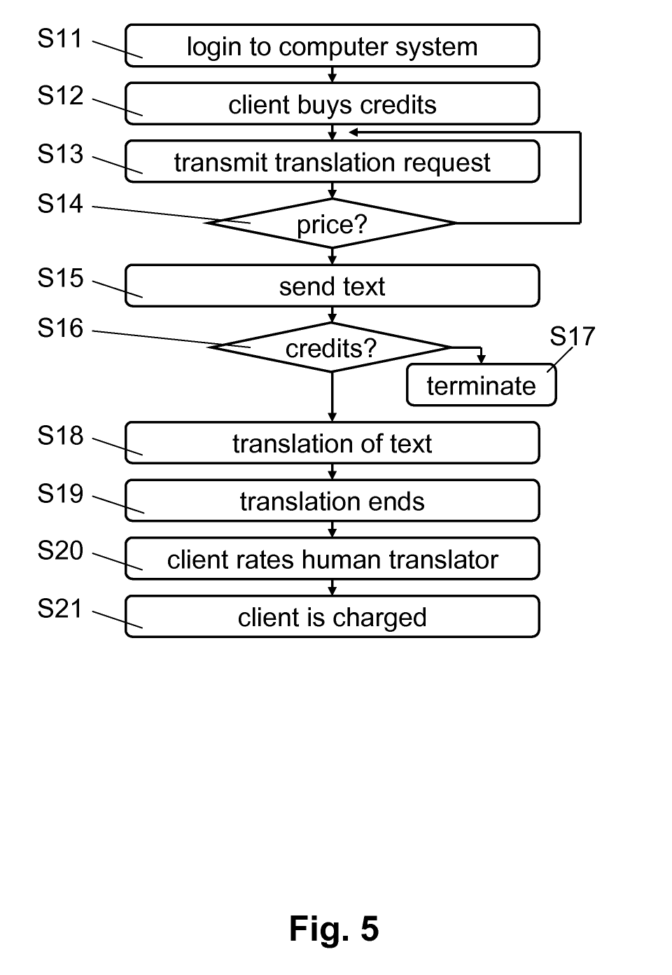

FIG. 5 shows a flow diagram illustrating a second further exemplary sequence of steps for setting up language translation services. This example relates to the case when a client writes a short text and receives instant online translation by a human translator.

In step S11, a client logs into the computer system 1, for example by providing a username and password assigned to the client's account. In step S12, the client buys credits, for example using a credit card or electronic payment system. In step S13, the client transmits a translation request to the computer system, indicating a source language, a target language, and a communication partner. In response, the client receives contact of a human translator and contacts the human translator. In step S14, the client and the human translator negotiate and try to agree on the price and costs for translation services. If they do not agree, the client looks for another translator and returns to step S13. If they agree, in step S15 the client sends the text to the human translator. In step S16 it is checked if the credits of the client are sufficient to translate the text. If the credits are not sufficient, in step S17 translation is terminated and the client has to buy credits again. If the credits are sufficient, in step S18 the human translator translates the text, wherein the client is charged for the translation services. In step S19, translation is ended, in particular by transmitting the translated text from the human translator to the client. In step S20, the client rates the human translator by transmitting rating data to the computer system 1. In step S21, the client is charged for the translation services by transferring an amount of money from an account of the client to an account of the human translator.

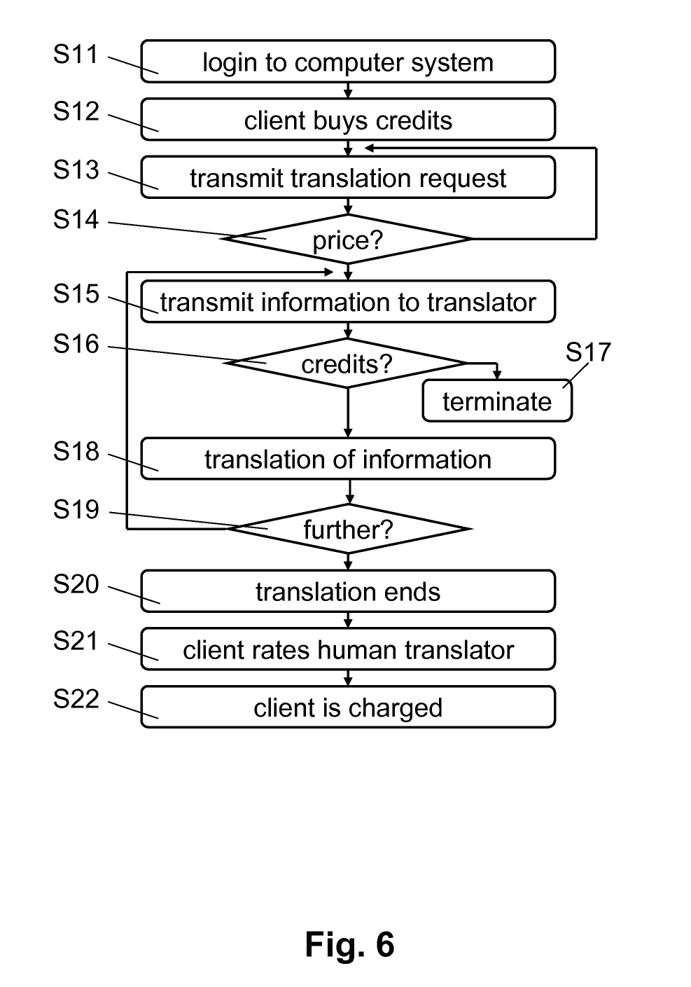

FIG. 6 shows a flow diagram illustrating a third further exemplary sequence of steps for setting up language translation services. This example relates to the case when a client needs a translator to get information in a foreign country.

In step S11, a client logs into the computer system 1, for example by providing a username and password assigned to the client's account. In step S12, the client buys credits, for example using a credit card or electronic payment system. In step S13, the client transmits a translation request to the computer system, indicating a source language, a target language, and a communication partner. In response, the client receives contact of a human translator and contacts the human translator. In step S14, the client and the human translator negotiate and try to agree on the price and costs for translation services. If they do not agree, the client looks for another translator and returns to step S13. If they agree, in step S15 the client calls the translator, wherein charging of the client for translation services is started. The client transmits information to be translated to the human translator. In step S16 it is checked if the credits of the client are sufficient to translate the information. If the credits are not sufficient, in step S17 translation is terminated and the client has to buy credits again. If the credits are sufficient, in step S18 the human translator translates the information, wherein the client is charged for the translation services. In step S19, it is checked if the client needs translation services for further information. If this is the case, in step S15 the client transmits information to be translated to the human translator. If the client does not need translation services for further information, in step S20 the translation is ended. In step S21, the client rates the human translator by transmitting rating data to the computer system 1. In step S22, the client is charged for the translation services by transferring an amount of money from an account of the client to an account of the human translator.

### REFERENCE SIGNS

1 computer system
2 registration module
21 profile database
3 service request module
31 request database
4 matching module
5 telecommunication network
6 calculation module
T1, T2, T3 translator terminal
C1, C2, C3 client terminal
P1, P2 partner terminal
CT communication link between client terminal and translator terminal
TP communication link between translator terminal and partner terminal

1. A computer system comprising one or more processors, the computer system being programmed to implement at least:
a registration module configured to receive translator profile data via a telecommunication network from human translators, and to store the translator profile data, the translator profile data including at least one source language and one target language;
a service request module configured to receive translation request data via the telecommunication network from clients, and to store the translation request data, the translation request data including at least a source language and a target language; and
a matching module configured to determine a set of human translators suitable for a translation request received from a client, using the translator profile data and the translation request data, and to set up a communication link between the client and a human translator selected from the set of human translators.

2. The computer system of claim 1, wherein the translation request data further includes addressing data of a communication partner assigned to the target language, and the matching module is further configured to set up a communication link between the communication partner and the selected human translator, using the addressing data of the communication partner, for enabling the selected human translator to act as an interpreter between the client and the communication partner.

3. The computer system of claim 1, wherein the matching module is configured to set up the communication link using at least one of: Voice over Inter Protocol, a video conference session, a telephone connection, a conference call connection, and instant messaging services.

4. The computer system of claim 1, wherein the service request module is configured to receive and store text data from clients; and the matching module is further configured to transmit the text data to the human translator, to receive translated text data from the human translator, and to transmit translated text data to the client.

5. The computer system of claim 1, wherein the registration module is further configured to receive and store availability information for the human translators; and the matching module is further configured to determine the set of human translators using the availability information.

6. The computer system of claim 1, wherein the service request module is further configured to receive and store scheduling information; and the matching module is further configured to set up the communication link between the client and the human translator using the scheduling information.

7. The computer system of claim 1, wherein the matching module is further configured to enable a cost of service negotiation between the client and the human translator, and to store a service agreement including an agreed upon cost of service.

8. The computer system of claim 1, wherein the computer system is further programmed to implement a calculation module configured to calculate and store service costs for a translation request using at least one of: cost of translation services for oral translation, cost of translation services for written translation, source language, target language, subject of expertise, level of translation difficulty, certificate of language skill, quality rating of human translator, number and languages of translation services performed by human translator, duration and languages of translation services performed by human translator, and date of registration of human translator.

9. The computer system of claim 1, wherein the service request module is further configured to receive and store with the translation request data at least one of: levels of requested translation difficulty, certificates of required language skills, cost of translation services for oral translation, cost of translation services for written translation, required subjects of expertise, and place of residence.

10. The computer system of claim 1, wherein the registration module is configured to further receive and store with the translator profile data at least one of: levels of offered translation difficulty, certificates of language skills, cost of translation services for oral translation, cost of translation services for written translation, subjects of expertise, place of residence, time zone, working hours, quality ratings, client references, number and languages of performed translation services, duration and languages of performed translation services, and date of registration.

11. A computer implemented method of setting up language translation services, the method comprising:
receiving translator profile data via a telecommunication network from human translators, and storing the translator profile data in a computer system, the translator profile data including at least one source language and one target language;
receiving translation request data via the telecommunication network from clients, and storing the translation request data in the computer system, the translation request data including at least a source language and a target language;
determining in the computer system a set of human translators suitable for a translation request received from a client, using the translator profile data and the translation request data; and
setting up by the computer system of a communication link between the client and a human translator selected from the set of human translators.

12. The method of claim 11, wherein the translation request data further includes addressing data of a communication partner assigned to the target language, and the communication link is set up between the communication partner and the selected human translator, using the addressing data of the communication partner, to enable the selected human translator to act as an interpreter between the client and the communication partner.

13. The method of claim 11, wherein the communication links are set up using at least one of: Voice over Inter Protocol, video conference session, telephone connection, conference call connection, and instant messaging services.

14. The method of claim 11, wherein the method further comprises receiving and storing in the computer system text data from clients; transmitting the text data to the human translator; receiving translated text data from the human translator; and transmitting translated text data to the client.

15. The method of claim 11, wherein the method further comprises receiving and storing in the computer system availability information of the human translators; and determining the set of human translators using the availability information.

16. The method of claim 11, wherein the method further comprises receiving and storing in the computer system scheduling information; and setting up the communication link between the client and the human translator using the scheduling information.

17. The method of claim 11, wherein the method further comprises negotiating in the computer system a cost of service between the client and the human translator; and storing a service agreement including an agreed upon cost of service.

18. The method of claim 11, wherein the method further comprises calculating and storing in the computer system service costs for a translation request, using at least one of: cost of translation services for oral translation, cost of translation services for written translation, source language, target language, subject of expertise, level of translation difficulty, certificate of language skill, quality rating of human translator, number and languages of translation services performed by human translator, duration and languages of translation services performed by human translator, and date of registration of human translator.

19. The method of claim 11, wherein the method further comprises receiving and storing in the computer system translation request data including at least one of: levels of requested translation difficulty, certificates of required language skills, cost of translation services for oral translation, cost of translation services for written translation, required subjects of expertise, and place of residence; and receiving and storing in the computer translator profile data including at least one of: levels of offered translation difficulty, certificates of language skills, cost of translation services for oral translation, cost of translation services for written translation, subjects of expertise, place of residence, time zone, working hours, quality ratings, client references, number and languages of performed translation services, duration and languages of performed translation services, and date of registration.

20. A computer program product comprising a computer readable medium having stored thereon computer program code configured to control one or more processors of a computer system such that the computer system performs the steps of:
receiving translator profile data via a telecommunication network from human translators, and storing the translator profile data, the translator profile data including at least one source language and one target language;
receiving translation request data via the telecommunication network from clients, and storing the translation request data, the translation request data including at least a source language and a target language;
determining a set of human translators suitable for a translation request received from a client, using the translator profile data and the translation request data; and
setting up a communication link between the client and a human translator selected from the set of human translators.
